(19) United States
(12) Patent Application Publication
(10) Pub. No.: US 2011/0283226 A1
(43) Pub. Date: Nov. 17, 2011

(54) WINDOW DISPLAY MANAGEMENT IN A GRAPHICAL USER INTERFACE

(75) Inventors: Sara H. Basson, White Plains, NY (US); Dimitri Kanevsky, Ossining, NY (US); Clifford A. Pickover, Yorktown Heights, NY (US); Tara N. Sainath, New York, NY (US)

(73) Assignee: International Business Machines Corporation, Armonk, NY (US)

(21) Appl. No.: 12/780,899

(22) Filed: May 15, 2010

(51) Int. Cl. G06F 3/048

(52) U.S. Cl. 715/794

(57) ABSTRACT

The present invention provides a computer implemented method and data processing system for effectively presenting popup and related windows on a computer GUI. An example system may include a computer processor coupled to the computer readable memory. The computer processor is configured to receive content of a new window for display in the display screen, perform a text analysis on the content of the new window to determine a relevance of the new window to the user, and determine a display position of the new window on the display screen based on the relevance of the new window to the user and a cursor position in the GUI displaying keyboard input such that the new window is displayed on the display screen at the determined display position.

### BACKGROUND

The present invention relates generally to a computer-implemented method, data processing system, and computer program product for controlling a graphical user interface. More specifically, the present invention relates to use of computer cursor locations, user histories, and window information for controlling popup window locations and shapes.

Modern networked computers provide tools for displaying windows on graphical user interfaces. Popup and related kinds of windows often appear in non-optimal locations on a display, such as when obscuring a computer user's work in progress. Popup windows on computer desktops, along with related forms of windows, are ubiquitous and include: modal windows (including popup dialog boxes), popup advertisements, application windows, and popup menus (a part of a computer interface).

Additionally, windows may be spawned simply by generation of one or more additional Web browser instances, as might be the case when a Web designer desires to keep an original window in place but display a second window.

In user interface design, a modal window is a child window that requires the user to interact with it before the user can return to operating the parent application, thus presenting impediments to the workflow and the user's cognitive focus with respect to the application main window. Sometimes modal windows appear as dialogue boxes displaying urgent information or a request to which a user must respond before proceeding with a task.

### SUMMARY

An example embodiment of the present invention is a method for displaying to a user a graphical user interface (GUI) on a display screen. The method includes a receiving step for receiving content of a new window for display in the display screen. A method performs a text analysis on the content of the new window using a computer processor to determine a relevance of the new window to the user. A determining step automatically determines a display position of the new window on the display screen based on at least the relevance of the new window to the user and a cursor position in the graphical user interface displaying keyboard input. A displaying step displays the new window on the display screen at the determined display position.

Another example embodiment of the invention is a system for displaying to a user a GUI on a display screen. The system includes a computer readable memory and a computer processor coupled to the computer readable memory. The computer processor is configured to receive content of a new window for display in the display screen, perform a text analysis on the content of the new window to determine a relevance of the new window to the user, and automatically determine a display position of the new window on the display screen based on at least the relevance of the new window to the user and a cursor position in the graphical user interface displaying keyboard input such that the new window is displayed on the display screen at the determined display position.

Yet another example embodiment of the invention is a computer program product for displaying to a user a GUI on a display screen. The computer program product includes computer readable program code configured to receive content of a new window for display in the display screen, perform a text analysis on the content of the new window using a computer processor to determine a relevance of the new window to the user, automatically determine a display position of the new window on the display screen based on at least the relevance of the new window to the user and a cursor position in the graphical user interface displaying keyboard input, and display the new window on the display screen at the determined display position.

Another example embodiment of the invention is a method for displaying to a user a graphical user interface on a display screen. The method includes receiving content of a new window for display in the display screen. A transparent region encompassing a cursor position in the graphical user interface displaying keyboard input is automatically provided in a portion of the new window. The new window is displayed on the display screen. A maintaining operation maintains the same cursor position before and after the new window is displayed.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example computer system for displaying to a user a graphical user interface on a display screen, as contemplated by the present invention.

FIG. 2 shows an example process for displaying to a user a graphical user interface on a display screen, as contemplated by the present invention.

FIG. 3 shows another example system embodiment of the present invention.

FIG. 4 shows a flowchart that a system may perform to mediate negotiation of a popup window with an illustrative embodiment of the invention.

### DETAILED DESCRIPTION

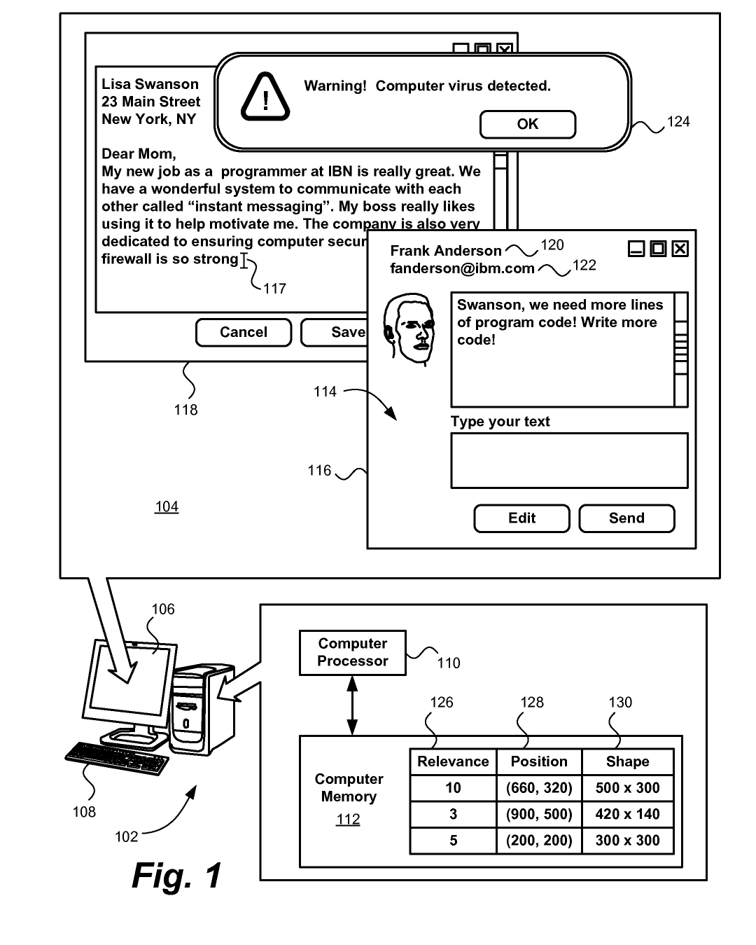

The present invention is described with reference to embodiments of the invention. Throughout the description of the invention reference is made to FIGS. 1-10.

FIG. 1 shows an example computer system 102 for displaying to a user a graphical user interface (GUI) 104 on a display screen 106, as contemplated by the present invention. The computer system 102 includes a keyboard 108 and a computer processor 110 coupled to computer memory 112. The computer system may be, for example, a general purpose computer, cellular phone, gaming device, or e-book reader.

As discussed in more detail below, the computer processor 110 is configured to receive content 114 of a new window 116 for display in the display screen 106. Before displaying the new window 116, the computer processor 110 performs a text analysis on the content 114 to determine a relevance of the new window 116 to the user. Based on the relevance of the new window 116 to the user and a cursor position 117 in the GUI displaying keyboard input, the computer processor 110 automatically determines a display position of the new window 116 on the display screen 106. The new window 116 is then displayed on the display screen 106 at the determined display position.

The system 102 enables users to work more effectively in typical GUI environments that involve multiple windows on a display 106. In many cases, a user does not want a popup or related kind of window to appear directly above his or her cursor 117, especially when the user is typing, thereby obscuring current work in progress. For example, a user may be editing a document in an existing window 118 with a cursor 117 indicating the current area of the display on which a user's attention is focused.

Before displaying a new window 116, the computer processor 110 examines the contents 114 of the window 116 and automatically determines its relevance to the user. For example, the computer processor 110 may determine that the new popup window 116 is an instant message from the user's supervisor based on a sender name 120 or email address 122 of the message. As such, the computer processor 110 may assign a high relevancy to the new window 116 and display it in a more prominent position on the display screen 106, such as close to the center of the user interface 104 and over the existing window 118. Conversely, if the computer processor 110 may determine that the new window 116 is not as relevant to the user and display the window 116 in a less prominent position on the display screen 106, such as to one corner of the user interface 104, behind the current window 118, or in a minimized form on a task bar.

In a particular embodiment of the invention, the computer processor 110 uses the relevance of the new window 116 to the user to automatically determine a window shape of the new window on the display screen. For example, a more relevant window may be displayed in a larger window. On the other hand, a less relevant window may be displayed in a smaller window. Differences in the location and/or the shape of the new windows displayed in the user interface 104 can thus provide an indication to the user about the urgency in which attention should be given to the new windows 116.

In another embodiment, the computer processor 110 provides a transparent region in a portion of the new window 116. The transparent region is automatically positioned on the new window 116 to encompass the cursor position 117. It is contemplated that the transparent region may be configured to be 100% transparent (i.e., a hole or cutout) or a lesser amount of transparency. Furthermore, the keyboard focus in the GUI does not change when the new window 116 is displayed. That is, the same application window receives keyboard input in the GUI before and after the new window 116 is displayed.

The system 102 may also use relevancy information to determine a location of keyboard focus on the user interface 104. For example, the computer processor 110 may compare the relevance of the new window 116 to a relevance of an existing window 118 receiving keyboard input. If the relevance of the new window 116 is less than the relevance of the existing window 118, the computer processor 110 will maintain keyboard input focus at the existing window 118.

Consider, for example, the scenario where the user is editing a letter in the existing window 118 when a new popup window 116 to be displayed on the user interface 104 is received. The computer processor 110 determines through text analysis of the new popup window's content 114 that it is an instant message from the user's boss. The computer processor 110 assigns a relatively high relevancy to the new popup window 116, but not enough to change to the keyboard focus from the active window 118 to the new window 116. Thus, the user can continue drafting the letter without interruption from the new window 116.

Next, a system warning message window 124 is received. The computer processor 110 determines through text analysis that the warning message window 124 is highly relevant to the user. The warning message window 124 is assigned a prominent position at the top center of the user interface 104. Furthermore, the computer processor 110 changes the keyboard focus from the existing window 118 to the warning message window 124. This causes the user stop drafting the letter address the system warning message window 124.

The text analysis performed by the computer processor 110 on the content 114 of the new window 116 may include searching the content 114 for a person's name, an email address, and/or a keyword. The relevance may also be dependent on content meta data, such as a security level of window (e.g., confidential/sensitive information displayed in the window) and the owner of window (e.g., the particular application that spawns window). It is contemplated that other forms of text analysis know to those skilled in the art may be used by embodiments of the invention, such as Bayesian filtering.

In one embodiment of the system 102, the computer memory 112 stores a plurality of relevances 126. Each relevance may be represented as an integer in an integer range. For example, a relevance of 10 may indicate the contents of a window is highly relevant to the user and a relevance of 1 may indicate the contents of the window are not very relevant to the user. For each relevance 126, the computer memory 112 may store an associated display position 128 and/or window shape 130. The associated position 128 may be, for example, in the form of (x, y) coordinates on the display screen 106. The associated window shape 130 may be, for example, in the form of a length and height of the window on the display screen 106.

At least some of the display position 128 and/or window shape 130 entries may be based on the user's historical positioning of sizing of windows with the same relevance. Conversely, at least some of the display position 128 and/or window shape 130 entries may be based on the based on the user's specified position preference.

It is contemplated that the computer processor may adjust the display position and/or size of the new window 116 if the relevance of the new window 116 is less than the relevance of the displayed window 118. For example, if the user is working on a window with a calculated high relevance, the size and shape of the new window may be adjusted so that the user's attention is not interrupted by the new window.

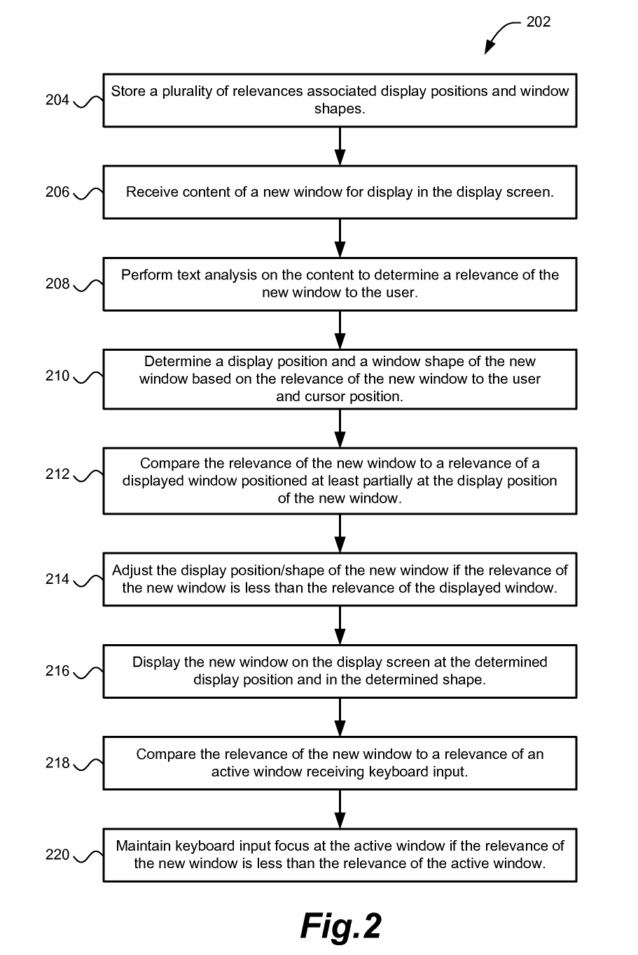

Turning now to FIG. 2, an example process 202 for displaying to a user a graphical user interface on a display screen contemplated by the present invention is shown.

The process starts at storing operation 204. During the storing operation 204, a plurality of relevances associated is stored in computer memory. Each relevance is associated with a display position and/or a window shape. As mentioned above, each relevance may, for example, be represented as an integer in an integer range. Furthermore, the display position may be represented as a pixel coordinate on the display, while the display shape may be represented as the pixel length and pixel height of the window. In one embodiment, the relevances, positions and shapes tuples are stored in a database.

At receiving operation 206, the content of a new window for display in the display screen is received. The content may include text, graphics, sound, and metadata. The metadata may include, for example, the application requesting display of the new window or the security protocol used to deliver the content. After receiving operation 206 is completed, control passes to determining operation 208.

At determining operation 208, the content is analyzed to determine the relevance of the new window to the user. As mentioned above, various techniques may be used to determine relevance, such as text analysis. Text analysis can include searching for a person's name, an email address, or a keyword, and/or applying Bayesian filtering. After determining operation 208 is completed, control passes to determining operation 210.

At determining operation 210, the display position and window shape of the new window on the display screen is determined. The position and shape can be based on at least the relevance of the new window to the user and the cursor position in the graphical user interface displaying keyboard input. For example, determining the display position and shape of the new window may include retrieving the display position and shape associated with the relevance of the new window from the computer memory. In a particular embodiment, at least some of the display positions and shapes are based on the user's historical positioning and resizing of windows with the same relevance. In further embodiments, at least some of the display positions and shapes are based on the user's specified window position and shape preference for the relevance. In one embodiment, a transparent region that encompasses the cursor position is provided in a portion of the new window.

Next, at comparing operation 212, the relevance of the new window is compared to a relevance of a displayed window positioned, at least partially, at the display position of the new window. At adjusting operation 214, the display position/shape of the new window is adjusted if the relevance of the new window is less than the relevance of the displayed window. For example, if the relevance of the displayed window is of higher relevance to the user than the new window, the new window's position or shape may be adjusted to not overlap the displayed window.

At displaying operation 216, the new window is displayed on the display screen.

At comparing operation 218, the relevance of the new window is compared to a relevance of an active window receiving keyboard input. The active window may or may not be the displayed window mentioned above. If, at operation 220, the relevance of the new window is less than the relevance of the active window, keyboard input focus is maintained at the active window. Thus, a new window with a lower relevance than the active window will not disrupt keyboard input from the user.

It is noted that the nature of cursor movements may be used to determine a user's cognitive dexterity (e.g., a beginning user may not be able to handle distractions as well as a multitasking experienced user.) The shape of a new window can take into account a cursor position. For example there can be a hole (visible or virtual) in a popup window exactly in a location of a cursor so that cursor does not cause writing into popped-up window. Or the popped-up windows can circumvent the cursor, i.e., move away from the cursor.

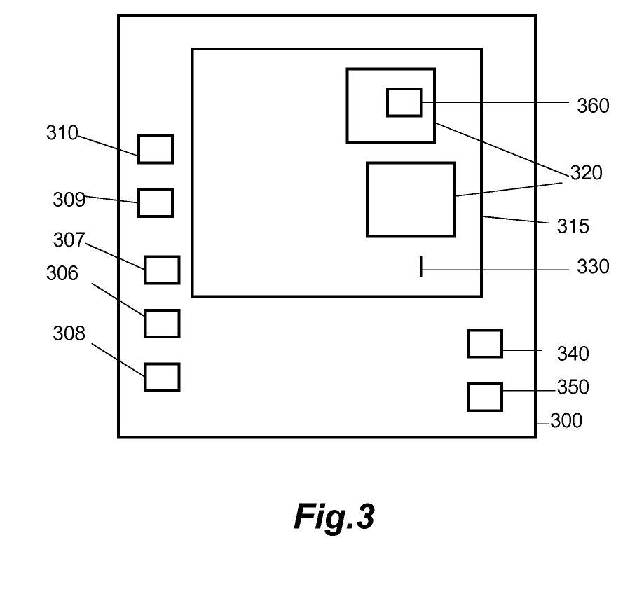

As mentioned, in order to improve human-computer interactions, the optimal location and shape of a popup window can be automatically determined by computations that may involve a text analysis of the window contents, the user's current cursor location and history of cursor use, a window relevance, reserved regions of the screen display, and user preferences. With reference now to FIG. 3, another example system for embodying the computer window system 300 contemplated by the invention is shown. This block diagram of a data processing system is shown in which aspects of an illustrative embodiment may be implemented.

The system 300, such as a desktop or portable computing device, may include a display screen 315 on which are displayed various windows 320 using a typical GUI (graphical user interface). The cursor position 330 may be indicated by some distinguishing characteristic, such as a blinking line or symbol.

Databases 340, 350 or other related means of storage may be used to store pertinent information such as associated with a users history of window use and positioning, cursor use and movements, and a user profile that may express preferences and other information. For example, a database may contain records containing information on regions of the computer screen to which a user drags windows from a particular user A. Consider the example in which a user always drags an instant message window, e.g. window 320, from a message sender A, to the top right of the screen. The database 340 may contain a record to indicate such actions, e.g. “Sender A, UR, 80%.” This database record may indicate that a user drags a window associated with Sender A to the upper right of the screen 80/100 times that a Sender A sends a message.

The databases 340, 350 may contain information on cursor dynamics. For example, a beginning user may have more erratic, jittery, or wandering cursor motions. These kinds of dynamics may be tracked and stored as x, y locations through time or in other forms. Other related histories, user preferences, and information may be stored in the databases.

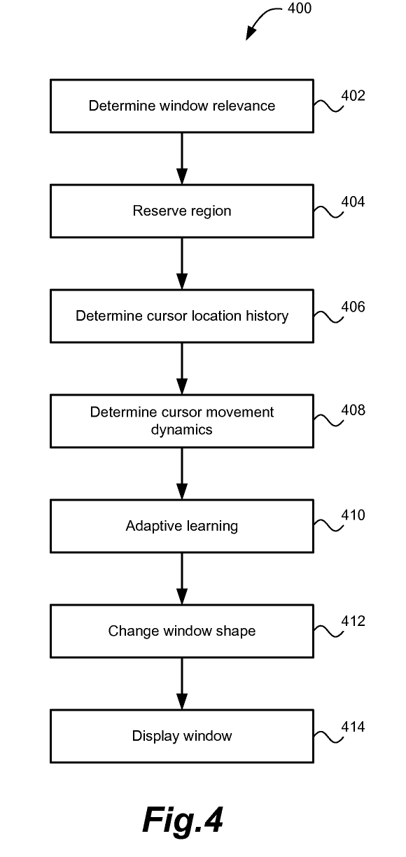

FIG. 4 shows example process steps that may be used in accordance with an embodiment of the present invention. In step 410, window relevance may be determined based on numerous factors such as window's content, security, sender, owner, and history, or based on a user profile stored in database 350. For example, the content of the window 320 may have to do with a subject such as cloud computing. This topic may be determined by known methods of analyzing words in a document or window.

In step 420, a region of the display may be reserved. For example, the upper right of the display may be reserved for the occurrence of popup windows, or, on the other hand, for the non-occurrence of popup windows. Information on these regions may be stored in the database 340, for example, in the form of words “upper right,” which may map to standard geometrical coordinates (e.g., pixels 500 to 1000 in the x and y directions on a 1024 by 1280 pixel display). Alternatively, various numerical specifications may be stored directly in the database, such as (500-1000, 500-1000) to indicate a range in the x and y directions. Regions might include the “center” of the display or the “sides” of the display.

In step 430, a history of use is determined. For example, the cursor motions may be tracked as a user uses device 300. If a user always moves a window to the upper right, this may represent a history of use.

In step 440, various cursor movement dynamics are tracked and optionally stored in database 350. For example, values for a user's speed (and dexterity) of use may be determined and stored as a single parameter or stored as a history of cursor locations.

In step 450, various adaptive learning may be taken. For example, the system may learn that user A tends to not care if windows occlude is view as he always devotes attention to them immediately and then closes the popup window. User B may always move his windows to the left if they are associated with a certain topic or instant-message sender. Thus, for user B, the system may learn to move certain windows with a particular topic to the left.

In step 460, a window shape may be determined based on, for example, window relevance (e.g. the content or topic of text in the window, the security of information in the window, the sender of the window). For example, it may be advantageous to place a cutout or hole in the center of the window. Additionally, the window may become thinner or taller. In step 470, the window is displayed.

Returning to FIG. 3, it is noted that the system 300, which may be a data processing system 300, is an example of a computer, in which code or instructions implementing the processes of the present invention may be located. Processor 306, main memory 308, and graphics processor 307 are shown. In the depicted example, local area network (LAN) adapter 309 is used for network connectivity.

An operating system 310 runs on processor 306, and coordinates and provides control of various components within data processing system 300 in FIG. 3. The operating system may be a commercially available operating system such as Microsoft® Windows® XP. Microsoft and Windows are trademarks of Microsoft Corporation in the United States, other countries, or both. An object oriented programming system, such as the Java programming system, may run in conjunction with the operating system and provides calls to the operating system from Java programs or applications executing on data processing system 300.

Instructions for the operating system, the object-oriented programming system, and applications or programs are located on storage devices, such as hard disk drives, and may be loaded into main memory for execution by processor 306. The processes of the present invention can be performed by processor 306 using computer implemented instructions, which may be located in a memory such as, for example, main memory, read only memory, or in one or more peripheral devices.

Those of ordinary skill in the art will appreciate that the hardware in FIG. 3 may vary depending on the implementation. Other internal hardware or peripheral devices, such as flash memory, equivalent non-volatile memory, and the like, may be used in addition to or in place of the hardware depicted in FIG. 3. In addition, the processes of the illustrative embodiments may be applied to a multiprocessor data processing system. In some illustrative examples, data processing system 300 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 308 or a cache. A processing unit may include one or more processors or CPUs. The depicted example in FIG. 3 is not meant to imply architectural limitations. For example, data processing system 300 also may be a tablet computer, laptop computer, or telephone device in addition to taking the form of a PDA.

As mentioned, relevance (e.g. importance, topic, security level) is determined from criteria such as content of window 320 (e.g. by text analysis of words), security level of window (e.g. confidential/sensitive information), the sender of the window (e.g. is the window associated with a particular person such as a spouse or a business manager with a particular job description), the owner of window (e.g. application that spawns window) and operating system.

A means is provided for learning the relevance of a popup window 320 from any of: history of user usage, user profile and formulas, or priority. Various baseline models can be provided that may be typical for different classes of users. The display 315 is on any of: computer, cell phone, gaming device, or e-book reader. The reserving of screen location is performed by any of: user, controlling program, controlling profile, or third party.

The location on the window 320 may be overridden (e.g. by the operating system or by another person such as computer support personnel). Window size and shape may also be controlled based on the various criteria. The nature of cursor movements may be used to determine a user's cognitive dexterity (e.g. a beginning user may not be able to handle distractions as well as a multitasking experienced user).

A shape of popup window can take into account a cursor position. For example, a hole or cutout 360 (visible or virtual) in a popup window may be generated at the location of a cursor so that cursor does not cause writing into popped-up window. The hole may be shaped like a quadrilateral or other shape. Or the popped-up windows can circumvent the cursor, i.e. move away from the cursor.

As an example scenario, a popup window 320 is about to appear. In many cases, a user does not want the window to appear directly above his or her cursor 330, especially when the user is typing, thereby obscuring current work in progress. The example system may determine the current cursor location 330 (and history of cursor locations, step 430 in FIG. 4) in an attempt to popup the Window in a position that is more optimal for the user. Because the location of the popup window may give an indication of the kind of popup window (such as information on the sender of a popup or information contained in the popup window contents), the user has a better feel for the message before even observing its contents. For example, if an automatic text analysis (e.g. topic analysis based on latent semantic indexing) of the popup window reveals it to deal with company strategy, the window may appear (popup) in the upper right-hand corner of the display, unless the user has his or her cursor already in this portion of the display, as may be the case when the user is editing a graphic using a paint program or typing into a text-processing program.

Additionally, the system may adaptively learn from user actions where to place popup windows. For example, if a user is continually shoving (e.g. moving) an instant-message window 320 (from his manager) that appeared in a distracting location (on top of the user's cursor 330) to the upper right of the screen, the system may learn from this action so that in the future, the window may popup in a more appropriate location. In other words, the system may learn where a user want windows to pop up in step 450 of FIG. 4 based a user's history of dragging his boss's windows (for example) to the upper right, and his spouse's window to the left. Learning parameters may be stored in databases 340 and 350.

The importance of the window shaping option, for example, for controlling the nature of the hole 360 in window 320, may be more critical in the event of popup windows on small portable screens 315, as in a mobile environment. Text messaging is pervasive on handheld devices and mobile phones. The strategies users depend on in larger computer desktop environments, such as shifting (moving) disruptive windows to another portion of the screen, are not feasible in the mobile environment, given the limited screen real estate.

The following scenario presents how window shaping and window transparency may be deployed, with an example in the mobile environment. Window transparency refers to one means by which the hole 360 may be rendered so that underlying text is visible. A user writes a text message on his portable (e.g. handheld) device. A popup window 320 appears (e.g. another message send by another user), that ordinarily would interfere with a user's attention at the current cursor position. The system performs text analysis on the message being typed (in step 410 of FIG. 4) and also on the content of the message in the popup window 320. A priority level is determined for each of the messages. A quadratic (e.g. quadrilateral) “hole” 360 may be created (step 460 in FIG. 4) around the cursor 330 that follows the cursor, thereby enabling the user to complete typing his message without interference from the popped up message. If the priority level of the user's text window (e.g. text message) is higher than the priority of the popped up message, the user is given sufficient time and space to complete the text in its entirety.

If the priority level of the user's text message is lower than the priority of the popped up message, the user is given a short time interval to complete or send the current text message before the focus shifts to the new incoming popup message. When the text message is complete, the hole is closed (e.g. hole 360 is removed and/or transparency is removed so that the window is opaque), and the user views the entire popup message.

It is possible to filter information for window prioritization. For example, the system may extract keywords from all documents and/or windows on the screen to determine an importance or relevance factor (step 410 of FIG. 4). For example, TV news articles may be rated as low importance, and messages from a user's manager may be rated as high importance.

When a new popup is displayed, the system determines what activity the user is engaged in with respect to the current screen and the importance of this windows (e.g. by analysis of the text in the window in step 410 of FIG. 4). The system determines the importance of all other documents and windows on display screen 315. The system then optionally makes the current window being looked at (i.e. the window that has primary focus) somewhat smaller and displays the new message (for example) below the current window. If the user does not respond to this message within a few minutes, it is placed in the background (sorted by importance or relevance factor), and the user's current window is then again enlarged.

As for a high-level architectural description, note that the Windows 32 API (application programming interface) is well-suited for implementation of basic features of the invention features. The following gives an example as to how some of mentioned features can be implemented in Windows. Note that this invention deals with a number of advanced Windows features such as continuation of “text flow” (e.g. the typing focus remains in a particular window even when another windows pops up) and graphical transparency.

One goal is to redirect the keyboard events to the appropriate window when a new window is popped up. To accomplish this, one can set a windows keyboard hook by calling Win32 SetWindowsHookEx( ) when typing starts, and remove it by calling UnhookWindowsHookEx( ) after the typing is finished, e.g. the <Enter> key is pressed in the popped-up window.

Once the keyboard hook is installed, all keyboard events go through that hook's procedure (see http://msdn.microsoft.com/en-us/library/ms633540(VS.85).aspx).

The window application (e.g., an instant-messaging system) that installs the hook is aware of its main window handle (HWND); thus, it uses it in the hook procedure to dispatch key messages to itself.

The second feature of window transparency for apportion of a window can be implemented using another API, or slight modification of the API, which is SetLayeredWindowAttributes (see http://msdn.microsoft.com/en-us/library/ms633540%28VS.85%29.aspx).

Finally, by calling SetFocus function (http://msdn.microsoft.com/en-us/library/ms646312%28VS.85%29.aspx), one can either keep focus on the window where the cursor is located or switch it to another window. The function allows, for example, text to continue to flow (e.g. be focused) in one window (that is hooked to a keyboard) even when another window pops up and focus is set on the other window.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention has been described, it will be understood that those skilled in the art, both now and in the future, may make various improvements and enhancements which fall within the scope of the claims which follow. Thus, the claims should be construed to maintain the proper protection for the invention first described.

What is claimed is:

1. A method for displaying to a user a graphical user interface on a display screen, the method comprising:
receiving content of a new window for display in the display screen;
performing a text analysis on the content of the new window using a computer processor to determine a relevance of the new window to the user;
automatically determining a display position of the new window on the display screen based on at least the relevance of the new window to the user and a cursor position in the graphical user interface displaying keyboard input; and
displaying the new window on the display screen at the determined display position.

2. The method of claim 1, further comprising:
providing a transparent region in a portion of the new window, the transparent region encompassing the cursor position; and
maintaining the same keyboard focus before and after the new window is displayed.

3. The method of claim 1, further comprising:
comparing the relevance of the new window to a relevance of an existing window positioned at least partially at the display position of the new window; and
adjusting the display position of the new window if the relevance of the new window is less than the relevance of the existing window.

4. The method of claim 1, further comprising:
storing in computer memory a plurality of relevances associated with a respective one of a plurality of display positions; and
wherein determining the display position of the new window includes retrieving the display position associated with the relevance of the new window from the computer memory.

5. The method of claim 4, wherein for at least some of the plurality of relevances, the display position associated with the relevance is based on the user's historical positioning of windows with the same relevance.

6. The method of claim 4, wherein for at least some of the plurality of relevances, the display position associated with the relevance is based on the user's specified position preference.

7. The method of claim 1, further comprising:
determining a window shape of the new window on the display screen based on the relevance of the new window to the user; and
displaying the new window on the display screen in the determined window shape.

8. The method of claim 1, further comprising:
comparing the relevance of the new window to a relevance of an existing window containing the cursor position; and
maintaining cursor position at the existing window if the relevance of the new window is less than the relevance of the existing window.

9. The method of claim 1, wherein performing the text analysis on the content of the new window includes searching the content of the new window for at least one of a person's name, an email address, and a keyword.

10. A system for displaying to a user a graphical user interface on a display screen, the system comprising:
computer readable memory; and
a computer processor coupled to the computer readable memory, the computer processor configured to receive content of a new window for display in the display screen, perform a text analysis on the content of the new window to determine a relevance of the new window to the user, and automatically determine a display position of the new window on the display screen based on at least the relevance of the new window to the user and a cursor position in the graphical user interface displaying keyboard input such that the new window is displayed on the display screen at the determined display position.

11. The system of claim 10, wherein the computer processor is further configured to:
provide a transparent region in a portion of the new window, the transparent region encompassing the cursor position; and
maintain the same keyboard focus before and after the new window is displayed.

12. The system of claim 10, wherein the computer processor is further configured to:
compare the relevance of the new window to a relevance of an existing window positioned at least partially at the display position of the new window; and
adjust the display position of the new window if the relevance of the new window is less than the relevance of the existing window.

13. The system of claim 10, further comprising:
a plurality of relevances associated with a respective one of a plurality of display positions stored in the computer readable memory; and
wherein the computer processor, in determining the display position of the new window, is further configured to retrieve the display position associated with the relevance of the new window from the computer readable memory.

14. The system of claim 13, wherein for at least some of the plurality of relevances, the display position associated with the relevance is based on the user's historical positioning of windows with the same relevance.

15. The system of claim 13, wherein for at least some of the plurality of relevances, the display position associated with the relevance is based on the user's specified position preference.

16. The system of claim 10, wherein the computer processor is further configured to:
determine a window shape of the new window on the display screen based on the relevance of the new window to the user; and
displaying the new window on the display screen in the determined window shape.

17. The system of claim 10, wherein the computer processor is further configured to:
comparing the relevance of the new window to a relevance of an existing window containing the cursor position; and
maintaining the cursor position at the existing window if the relevance of the new window is less than the relevance of the existing window.

18. The system of claim 10, wherein the computer processor, in performing the text analysis on the content of the new window, is further configured to search the content of the new window for at least one of a person's name, an email address, and a keyword.

19. A computer program product for displaying to a user a graphical user interface on a display screen, the computer program product comprising:
a computer readable storage medium having computer readable program code embodied therewith, the computer readable program code configured to:
receive content of a new window for display in the display screen;
perform a text analysis on the content of the new window using a computer processor to determine a relevance of the new window to the user;
automatically determine a display position of the new window on the display screen based on at least the relevance of the new window to the user and a cursor position in the graphical user interface displaying keyboard input; and
display the new window on the display screen at the determined display position.

20. The computer program product of claim 19, further comprising computer readable program code to:
provide a transparent region in a portion of the new window, the transparent region encompassing the cursor position; and
maintain the same keyboard focus before and after the new window is displayed.

21. The computer program product of claim 19, further comprising computer readable program code to:
compare the relevance of the new window to a relevance of an existing window positioned at least partially at the display position of the new window; and
adjust the display position of the new window if the relevance of the new window is less than the relevance of the existing window.

22. The computer program product of claim 19, further comprising computer readable program code to:
store in computer memory a plurality of relevances associated with a respective one of a plurality of display positions; and
wherein the computer readable program code to determine the display position of the new window includes computer readable program code to retrieve the display position associated with the relevance of the new window from the computer memory.

23. The computer program product of claim 19, further comprising computer readable program code to:
determine a window shape of the new window on the display screen based on the relevance of the new window to the user; and
display the new window on the display screen in the determined window shape.

24. A method for displaying to a user a graphical user interface on a display screen, the method comprising:
receiving content of a new window for display in the display screen;
automatically providing a transparent region in a portion of the new window, the transparent region encompassing a cursor position in the graphical user interface displaying keyboard input;
displaying the new window on the display screen; and
maintaining the same keyboard focus before and after the new window is displayed.
